(19) United States
(12) Patent Application Publication
(10) Pub. No.: US 2013/0187934 A1
(43) Pub. Date: Jul. 25, 2013

(54) APPARATUS AND METHOD FOR PROCESSING A SIGNAL

(71) Applicant: SAMSUNG ELECTRONICS CO., LTD., Suwon-si (KR)

(72) Inventors: Sang-woo KIM, Hwaseong-si (KR); Yoon-kyung CHOI, Seoul (KR)

(73) Assignee: SAMSUNG ELECTRONICS CO., LTD., Suwon-si (KR)

(21) Appl. No.: 13/750,064

(22) Filed: Jan. 25, 2013

(30) Foreign Application Priority Data
Jan. 25, 2012 (KR) 10-2012-0007196

(51) Int. Cl. G06T 1/00

(52) U.S. Cl. CPC G06T 1/00
USPC 345/501

(57) ABSTRACT

A method of processing a signal, the method including receiving first data, extracting a first parameter from the first data, calculating and outputting first output data with respect to the first data based on the first parameter, receiving second data, extracting a second parameter from the second data, calculating second output data with respect to the second data based on the second parameter, and alternately outputting the first and second output data at least once.

### CROSS-REFERENCE TO RELATED APPLICATIONS

This application claims priority under 35 U.S.C. §119 to Korean Patent Application No. 10-2012-0007196 filed on Jan. 25, 2012, in the Korean Intellectual Property Office, and entitled: “Apparatus and Method for Processing Signal,” the entire contents of which is hereby incorporated by reference.

### BACKGROUND

1. Field

Embodiments relate to an apparatus and method for processing a signal.

2. Description of the Related Art

Signal processing, for example, image signal processing, which is a technology that may be used in an apparatus for capturing an external image and an apparatus for displaying the captured image, may be applied to a large variety of electronic devices.

### SUMMARY

Embodiments are directed to a method of processing a signal, the method including receiving first data, extracting a first parameter from the first data, calculating and outputting first output data with respect to the first data based on the first parameter, receiving second data, extracting a second parameter from the second data, calculating second output data with respect to the second data based on the second parameter, and alternately outputting the first and second output data at least once.

The method may further include outputting the second output data after alternately outputting the first and second output data.

The first parameter and the second parameter may have different values.

The first and second output data may be output in units of frames.

The first and second output data respectively may have first and second gradations from among K-gradations, wherein K is a positive integer, and alternately outputting the first and second output data may visually appear as third output data having at least one gradation between the first gradation and the second gradation.

The K-gradations may have gradation values that increase or decrease according to a reference unit, and the third output data may appear to have a gradation value that increases or decreases according to a unit smaller than the reference unit.

The third output data may include a plurality of frames.

Embodiments are also directed to a method of processing a signal, the method including receiving first data, extracting a first parameter from the first data, receiving second data, extracting a second parameter from the second data, comparing the first parameter and the second parameter, and as a result of the comparison, if the first and second parameters are different from each other, at least once alternately outputting first output data generated based on the first parameter and second output data generated based on the second parameter.

As a result of the comparison, if the first parameter is the same as the second parameter, the second output data generated based on the second parameter may be output.

The method may further include outputting the second output data after alternately outputting the first and second output data.

The first and second output data respectively may have first and second gradations from among K-gradations, wherein K is a positive integer, and alternately outputting the first and second output data may visually appear as third output data having at least one gradation between the first gradation and the second gradation.

Embodiments are also directed to a signal processing apparatus, including a parameter calculator for calculating a first parameter for first data and a second parameter for second data, a processing unit for generating first output data based on the first parameter and second output data based on the second parameter, and a controller for controlling the first and second output data to be alternately output at least once if the first and second parameters are different from each other.

The signal processing apparatus may further include an analyzer for analyzing the first and second data to output a result of the analysis to the controller.

The controller may compare the first and second parameters.

The signal processing apparatus may further include a selector for receiving the first and second parameters and selectively outputting the first and second parameters to the processing unit under the control of the controller.

The controller may control the second output data to be output if the first parameter is the same as the second parameter.

The controller may control the second output data to be output after the first and second output data are alternately output, if the first and second parameters are different from each other.

The controller may include a control pattern generator for generating a control pattern that controls the first and second output data to be alternately output at least once.

The processing unit may generate the first and second output data by operating on some data selected from the second data to n-th data with the first parameter and operating on other data selected from the second data to the n-th data with the second parameter, wherein n is an integer equal to or greater than 3.

The processing unit may generate the first output data by enhancing a first image signal based on the first processing parameter to produce a first enhanced image signal, and may generate the second output data by enhancing a second image signal based on the second processing parameter to produce a second enhanced image signal.

### BRIEF DESCRIPTION OF THE DRAWINGS

Features will become apparent to those of skill in the art by describing in detail exemplary embodiments with reference to the attached drawings in which:

FIG. 1 illustrates a block diagram of a signal processing apparatus according to an embodiment;

FIG. 2 illustrates a block diagram of an image signal processing apparatus including the signal processing apparatus 10 of FIG. 1;

FIG. 3 illustrates a block diagram of a signal processing apparatus according to an embodiment;

FIGS. 4A, 4B, and 4C illustrate effects of the embodiments according to a temporal property of vision;

FIG. 5A illustrates a flowchart of a signal processing according to an embodiment;

FIG. 5B illustrates a flowchart of a signal processing according to an embodiment;

FIG. 6A illustrates a flowchart of a signal processing according to an embodiment;

FIG. 6B illustrates a flowchart of a signal processing according to an embodiment;

FIGS. 7A and 7B illustrate block diagrams of a signal processing apparatus according to an embodiment;

FIGS. 8A and 8B illustrate an example of an optional output of a parameter according to an embodiment;

FIG. 9 illustrates a block diagram of a signal processing apparatus according to an embodiment;

FIG. 10 illustrates a block diagram of an image signal processing apparatus including the signal processing apparatus of FIG. 9;

FIG. 11 illustrates a block diagram of a signal processing apparatus according to an embodiment;

FIG. 12 illustrates a block diagram of a signal processing apparatus according to an embodiment;

FIG. 13 illustrates a block diagram of a signal processing apparatus according to an embodiment;

FIG. 14 illustrates a block diagram of an image signal processing apparatus including the signal processing apparatus of FIG. 13;

FIG. 15 illustrates a block diagram of a display apparatus according to an embodiment; and

FIG. 16 illustrates a block diagram of an example of an interface used in a computing system according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. Like reference numerals refer to like elements throughout.

As used herein, the term “and/or” includes any and all combinations of one or more of the associated listed items. Expressions such as “at least one of,” when preceding a list of elements, modify the entire list of elements and do not modify the individual elements of the list.

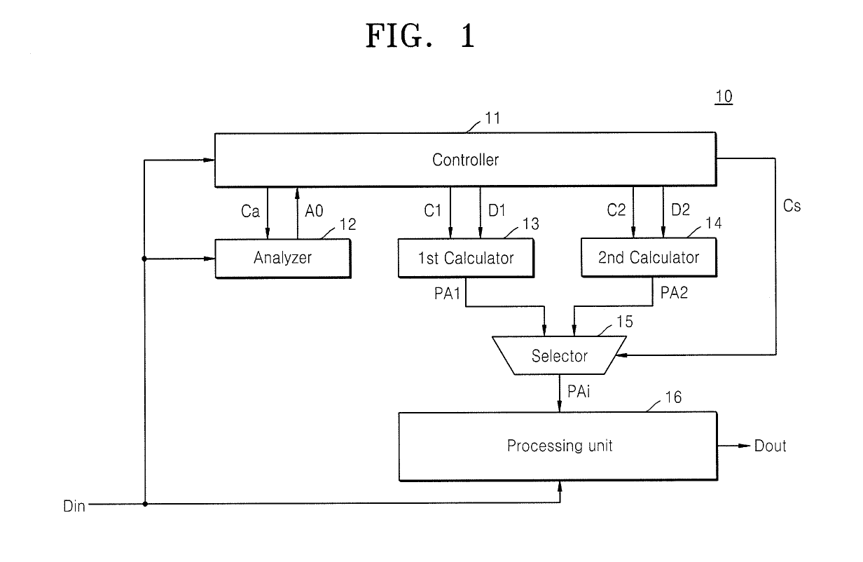

FIG. 1 illustrates a block diagram of a signal processing apparatus 10 according to an embodiment.

Referring to FIG. 1, the signal processing apparatus 10 may include an analyzer 12, a controller 11, a first parameter calculator 13, a second parameter calculator 14, a selector 15, and a processing unit 16.

Input data Din, which may be a digital value, may be expressed by one of the values determined in a predetermined range. Thus, if a video signal is provided to the signal processing apparatus 10, the video signal may include a plurality of pieces of pixel data, and the input data Din each may be a piece of the pixel data. The input data Din may be expressed by at least one bit according to resolution. For example, the input data Din may be an 8-bit, 9-bit, or 10-bit video signal. If the input data Din is an 8-bit video signal, the input data Din may have a value in a range of 0 to 255, if the input data Din is a 9-bit video signal, the input data Din may have a value in a range of 0 to 511, and if the input data Din is a 10-bit video signal, the input data Din may have a value in a range of 0 to 1023. The video signal may include RGB color components.

Also, output data Dout may be expressed in a gradation value. For example, if the input data Din is an 8-bit video signal, the output data Dout may have 256 gradations. In this case, the gradations of the output data Dout may have a gradation value that increases or decreases according to a reference unit (one gradation) as a minimum expression range. The reference unit is determined according to resolution of the input data Din. For example, if the input data Din is an 8-bit video signal, the minimum expression range may have a relatively small variation width of 1/256. If the input data Din is a 6-bit video signal, the minimum expression range may have a relatively large variation width of 1/64.

The analyzer 12 may output an analysis result A0 by analyzing the input data Din. The analysis result A0 may include results such as, e.g., an average value, variance, standard deviation, a histogram analysis of the input data Din, and the like. The analysis result A0 produced by the analyzer 12 may be provided to the controller 11. The analyzer 12 may be operated according to a control signal Ca of the controller 11.

The controller 11 may select a parameter PAi to be output from among results PA1 and PA2 of a calculation performed by first and second parameter calculators 13 and 14 based on the analysis result A0 and output frequency control information. The output frequency control information refers to information regarding controlling the frequency in which pieces of output data Dout (e.g., two pieces of output data Dout that are temporally adjacent to each other) are repeatedly and alternately output.

The analyzer 12 may be periodically operated. For example, a period may be one frame if the input data Din is the video signal. In addition to the periodic operation, the analyzer 12 may perform an analysis operation through control from the outside when the input data Din changes, and may not perform the analysis operation if the input data Din does not change. For example, if the video signal is a still image signal, it may be highly unlikely that the input data Din changes, and thus the analyzer 12 may skip the analysis operation.

The controller 11 may perform a control operation on itself, or may be controlled according to control signals (not shown) provided from the outside. Although the controller 11 is shown as an individual element in FIG. 1, the controller 11 may include one or more of the analyzer 12, the first and second parameter calculators 13 and 14, and the selector 15.

The first and second parameter calculators 13 and 14 may calculate a parameter with respect to the corresponding data by using the analysis result A0 of the analyzer 12. If there are three pieces of data that are alternately output, three parameter calculators may be provided in response to the three pieces of data.

For example, the parameter may have a value relating to luminance if the input data Din is the video signal. Thus, the controller 11 may determine whether the luminance of the input data Din is changed from luminance of a previous signal based on the analysis result A0. Operations of the first and second parameter calculators 13 and 14 may be controlled according to control signals C1 and C2 provided from the controller 11, and data D1 and D2 may be provided to the first and second parameter calculators 13 and 14, respectively, for calculation of the respective parameters. The first and second parameter calculators 13 and 14 may calculate and output the first and second parameters PA1 and PA2, respectively.

If the first and second parameters PA1 and PA2 have the same value, the two corresponding pieces of data (e.g., continuous pieces of data) may not be significantly different, and thus, there may be no need to alternately output the two pieces of data. In this case, the selector 15 may be controlled through a control signal Cs so that the second parameter PA2, instead of the first parameter PA1, may be selected and output as the parameter PAi to be used to calculate output data. If the first and second parameters PA1 and PA2 have different values, the selector 15 may be controlled through a control signal Cs, based on output frequency control information, so that the first parameter PA1 and the second parameter PA2 are alternately selected.

The selected parameter PAi may be provided to the processing unit 16. The processing unit 16 may perform an operation on the selected parameter PAi and the input data Din, and then generate the output data Dout.

The controller 11 may determine a variation in a parameter by using the analysis result A0 provided from the analyzer 12, or by using outputs of the first and second parameter calculators 13 and 14. When the variation in the parameter is determined by using the outputs of the first and second parameter calculators 13 and 14, the analyzer 12 may be omitted.

The processing unit 16 may perform a predetermined functional operation by using the input data Din and the selected parameter PAi. The functional operation may include a relatively complicated calculation, e.g., including four fundamental arithmetic operations.

Hereinafter, operations of the above-described signal processing apparatus 10 will be described by taking image processing of an image signal as an example. If the input data Din corresponding to the first parameter PA1 has resolution of about 16M, a minimum expression range of the output data Dout may be 1/256. If the input data Din corresponding to the second parameter PA2 has resolution of about 260K, a minimum expression range of the output data Dout may be 1/64, which is four times the minimum expression range of the 16M resolution. In other words, the minimum expression range in the case of the 260K resolution is four times the minimum expression range in the case of the 16M resolution, and thus, a variation in one gradation may be relatively easily recognized in an image. The difference in the minimum expression range may be a problem in a sliding operation of an image.

As such, when an image performs a sliding operation in which the image is gradually changed into a different image (e.g., without changing its position), variations may occur in parameters applied to an existing image due to an influence of image enhancement. The variations in the parameters may affect a pixel value of the existing image. In addition, even if a relatively complicated algorithm is used, the minimum expression range (one gradation) of the output data Dout may be determined according to color resolution of each device. In a device having a relatively high resolution (e.g., about 16M), there may be a relatively small variation width between gradations, and thus, the variation width may not be visually recognized and may be smoothly expressed. However, in a relatively low resolution (e.g., equal to or less than 260K), a variation width of one gradation may be relatively large, and thus, the variation width may be visually recognized as a flicker.

In FIG. 1, the signal processing apparatus 10 is configured to calculate two parameters, and thus, the output frequency control information may include information that allows the two parameters to be selectively output. Thus, the output data Dout, may be calculated and output based on the first parameter PA1 output from the first parameter calculator 13, or the second parameter PA2 output from the second parameter calculator 14. The controller 11 may control the first parameter PA1 and the second parameter PA2 to be alternately output by controlling the selector 15 through the control signal Cs. After the first parameter PA1 and the second parameter PA2 are alternately output, the second parameter PA2 may be output. The processing unit 16 may calculate and output the output data Dout by using the corresponding parameter PAi.

In the case of an image signal, a repetitive timing of each parameter (e.g., the time during which output data Dout corresponding to the each parameter is output) may correspond to one frame. If the output data Dout corresponding to the first and second parameters PA1 and PA2 are alternately output at a step of variation between the first and second parameters PA1 and PA2, a temporal property of vision, (e.g., the manner in which alternating images appear to human beings), may result in the alternately output data Dout corresponding to the first and second parameters PA1 and PA2 being visually recognized (i.e., appearing to the human eye) as an intermediate value of the plurality pieces of output data Dout corresponding to the first and second parameters PA1 and PA2. That is, during the process in which the first and second parameters PA1 and PA2 are alternated, an average of the variations for a predetermined period of time may be visually recognized.

Accordingly, when the first and second parameters PA1 and PA2 changes, it may be visually recognized as having an intermediate step of the two steps, and thus smooth switching of an image may be achieved.

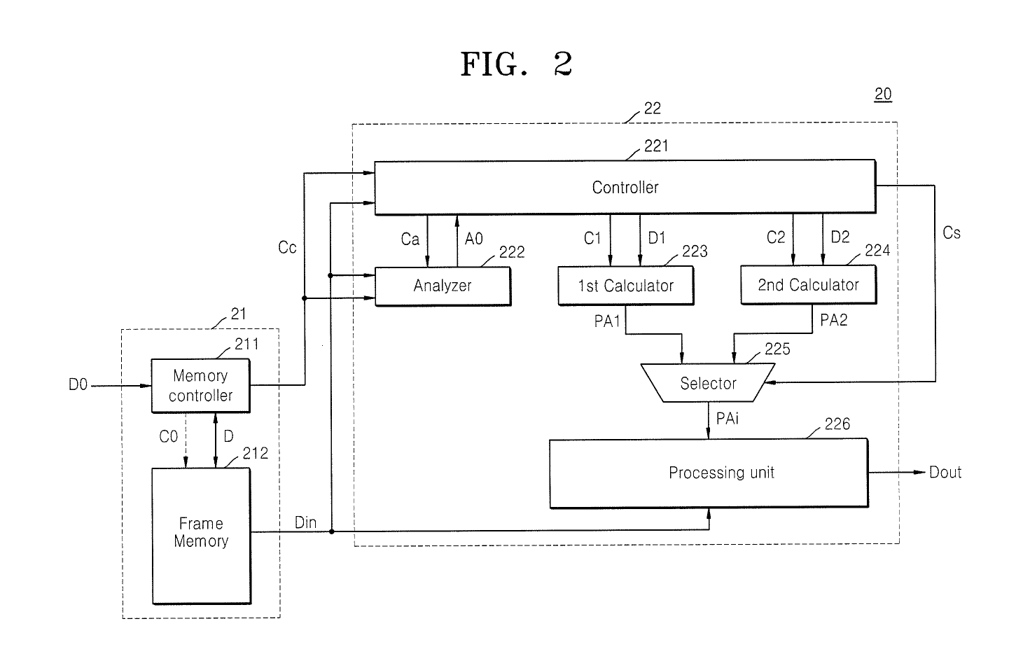

FIG. 2 illustrates a block diagram of an image signal processing apparatus 20 including the signal processing apparatus 10 of FIG. 1.

Referring to FIG. 2, the image signal processing apparatus 20 may include a signal processing apparatus 22 and a graphic memory 21. The graphic memory 21 may include a memory controller 211 and a memory 212. An input signal D0 may be a video signal. The memory controller 211 may control reading and writing of the video signal D from and to the memory 212 through a command C0. The command C0 may include an address signal. The input signal D0 may include a plurality of pieces of data. For example, if the input signal D0 is a video signal in frame units, the input signal D0 may include a plurality of pieces of pixel data included in a frame. The pixel data may be sequentially provided to the signal processing apparatus 22 as the input data Din.

The memory 212 may respond to control of the memory controller 211 and may include a frame memory. Thus, if the input signal D0 is the video signal in frame units, the input signal D0 may be stored in frame units. The memory controller 211 may control an operation of the signal processing apparatus 22 through a control signal Cc. The control signal Cc may include a clock signal Clock (not shown) for synchronizing the graphic memory 21 and the signal processing apparatus 22. Although not shown, the graphic memory 21 and/or the signal processing apparatus 22 may further include a delay-locked loop (DLL) or a phase-locked loop (PLL) for compensating for a signal delay difference between an internal circuit and an interface.

The elements of the signal processing apparatus 22 of FIG. 2 may be materially the same as the signal processing apparatus 10 of FIG. 1, and thus, a detailed description thereof will not be repeated.

The controller 221 may control an analyzer 222, first and second parameter calculators 223 and 224, and a selector 225 through control signals Ca, C1, C2, and Cs by receiving the control signal Cc from the memory controller 211. The controller 221 may perform a control operation on itself, or may be omitted if the controller 221 performs only a relatively simple interface function.

Here, the control signal Cc may control an operation for updating a parameter if the parameter changes. Thus, the control signal Cc may be directly provided to the analyzer 222, or may be provided as the control signal Ca to the analyzer 222 through the controller 221.

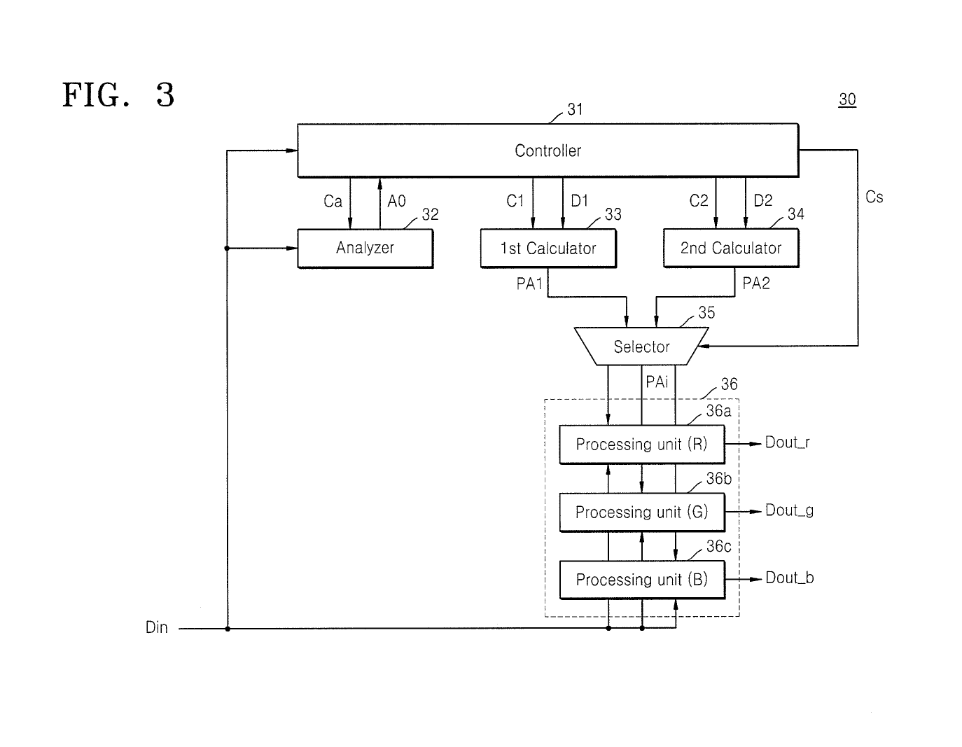

FIG. 3 illustrates a block diagram of a signal processing apparatus 30 according to an embodiment.

Referring to FIG. 3, the signal processing apparatus 30 may include a controller 31, an analyzer 32, first and second parameter calculators 33 and 34, a selector 35, and a processing unit 36.

The elements and the operation of the signal processing apparatus 30 of FIG. 3 may be materially the same as the signal processing apparatus 10 of FIG. 1, and thus, a detailed description thereof will not be repeated.

In FIG. 3, The processing unit 36 may include three sub-processing units 36a, 36b, and 36c corresponding to three colors of red R, green G, and blue B. However, an input signal Din may have three colors of red R, green G, and blue B, and a predetermined bit of data for each color, and thus, constructions of an interface and a internal circuit may need to be changed accordingly. Suitable colors may be included in the input signal Din, and although the input signal Din has the R, G, and B colors in the present embodiment, the input signal Din may further include complementary colors, e.g., magenta Mg, cyon Cy, yellow Ye, white W, black B, etc.

The sub-processing units 36a to 36c may receive a parameter PAi and the input pieces of data Din, which correspond to each color, and may calculate the parameter PAi and the input data Din to generate a plurality of pieces of output data Dout_r, Dout_g, and Dout_b.

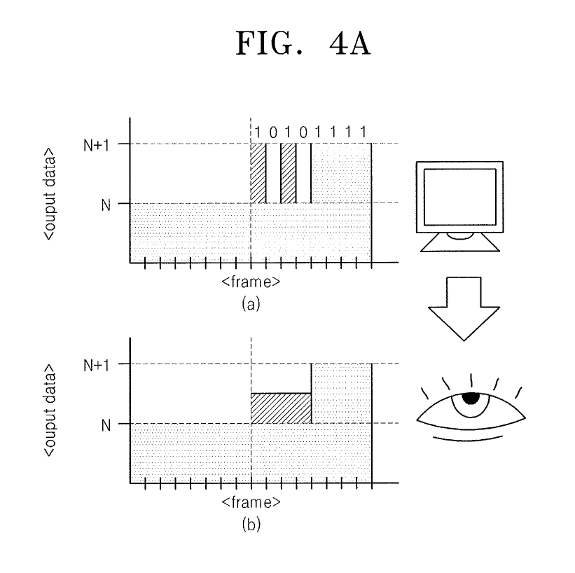

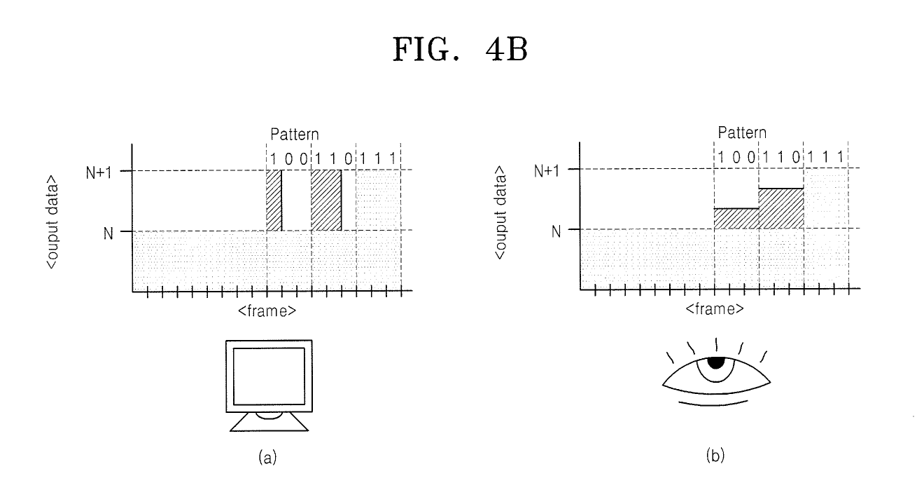

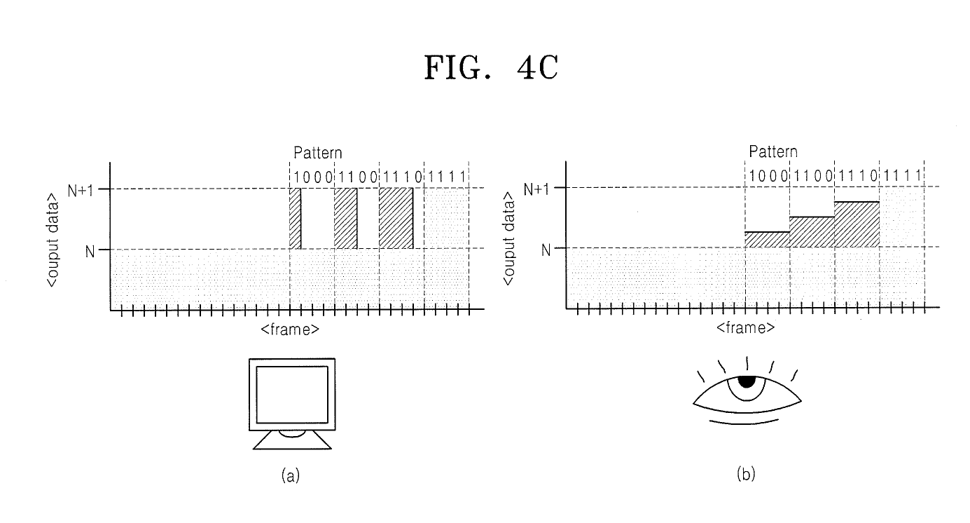

FIGS. 4A, 4B, and 4C illustrate views for describing effects of the embodiments according to a temporal property of vision. In FIGS. 4A, 4B, and 4C, the crosses along the <frame> axis indicate the frames of an image signal.

FIG. 4A shows a temporal property of vision with respect to a variation in a parameter of an image signal. A view (a) of FIG. 4A shows a state when the above-described first and second parameters are alternately selected, and thus, output data is calculated and output. A view (b) of FIG. 4A shows a visual recognition characteristic of a human according to the alternating application of the two parameters shown in the view (a) of FIG. 4A.

For example, while output data having a gradation ‘N’ is being output by the previous parameter (for example, the first parameter), the parameter applied to an image may need to be changed by image enhancement to change the output data having the gradation ‘N’ into output data having a gradation ‘N+1’. Here, if the previous parameter and the current parameter (for example, the second parameter) are output in the order of ‘1010’, a gradation ‘N+½’, which is an intermediate value between the gradations ‘N’ and ‘N+1’, may be recognized by a vision of a human, thereby obtaining an effect in which an image signal is expressed in a unit of ‘½’ which is a minimum unit of a gradation variation. Accordingly, an image may be smoothly switched, thereby substantially preventing generation of flickering.

FIG. 4B illustrates a view for describing effects of the embodiments according to a temporal property of vision.

Although FIG. 4A shows a case where one intermediate gradation value is between two gradations of output data, FIG. 4B shows a case where two intermediate gradation values are between two gradations of output data. A greater number of frames may be additionally assigned in terms of time, and thus the smooth switching of an image may be further improved.

For example, output data having a gradation ‘N’ may be output by the previous parameter, and a pattern for controlling a selective output of the parameter may be ‘000’. Also, patterns for controlling a selective output of the parameter may be ‘100’ and ‘110’. One current parameter (for example, the second parameter) and two previous parameters (for example, two first parameters) may be output over three frames by the control pattern ‘100’. In this case, the output data having the gradation ‘N’ is output from two frames, and the output data having the gradation ‘N+1’ is output from one frame, and thus, the output data may be recognized as having a gradation ‘N+⅓’. Also, two current parameters and one previous parameter may be output over three frames by the control pattern ‘110’. In this case, the output data may be recognized as having a gradation ‘N+⅔’. Then, a control pattern ‘111’ follows. Thus, two intermediate values having sequentially different values are located between two parameters, thereby enabling the smooth switching of an image to be further improved.

FIG. 4C illustrates a view for describing effects of the embodiments according to a temporal property of vision.

Although one or two intermediate values are between two gradations in FIGS. 4A and 4B, three intermediate values are between two gradations in FIG. 4C. A greater number of frames may be additionally assigned in terms of time, and thus the smooth switching of an image may be further improved.

For example, output data having a gradation ‘N’ is output by the previous parameter, having a pattern of ‘0000’. Also, patterns for controlling a selective output of the parameter are ‘1000’, ‘1100’, and ‘1110’. One current parameter (for example, the second parameter) and three previous parameters (for example, the first parameter) are output over four frames by the control pattern ‘1000’, and two current parameters and two previous parameters are output over four frames by the control pattern ‘1100’. Also, three current parameters and one previous parameter are output over four frames by the control pattern ‘1110’. Then, a control pattern ‘1111’ follows. In this case, three intermediate values having sequential different values are located between two parameters, thereby enabling the smooth switching of an image to be further improved.

The signal processing apparatus may be configured to have a greater number of intermediate values. In this case, the number of calculators of FIG. 1 may be increased to correspond to the number of intermediate values. If the signal processing apparatus includes one calculator, the number of registers for storing a result of a calculation may be increased.

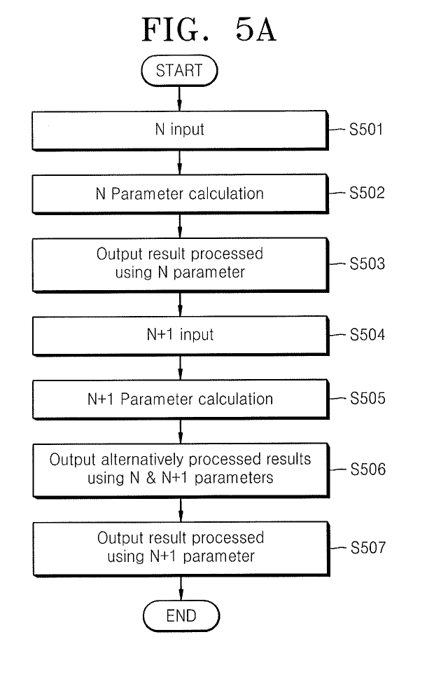

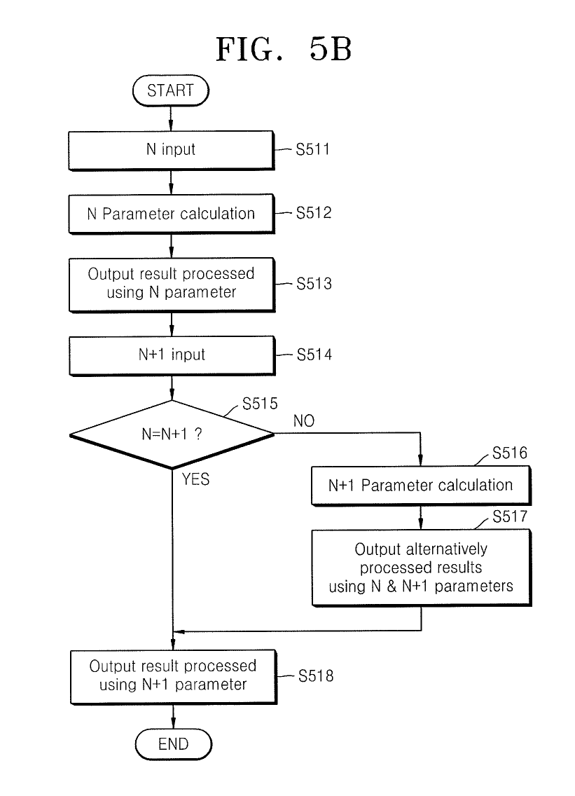

FIG. 5A illustrates a flowchart showing signal processing according to an embodiment.

Referring to FIG. 5A, N-th input data (for example, the current input data) is input to a signal processing apparatus (operation S501). The N-th input data may include a pixel signal having RGB color components and gradation information. An N-th parameter is calculated by using the N-th input data (operation S502).

When an image signal is processed, luminance, contrast, etc. may be controlled to improve characteristics, such as color or resolution, of the image signal by using, for example, a histogram or controlling a gain, which may be referred to as image enhancement. For example, the above-described N-th parameter may be represented by a gain that increases or decreases luminance for image enhancement.

Output data is calculated through a processing unit by using the N-th parameter and the N-th input data, and a result of the calculation is output (operation S503), which may be regarded as the above-described image enhancement.

Next, N+1-th input data is input to the signal processing apparatus (operation S504). Then, an N+1-th parameter with respect to the N+1-th input data is calculated (operation S505), and output data based on the N+1-th parameter is calculated. Here, the two data signals (the N-th and N+1-th input data) input may have different parameter values used to enhance luminance, contrast, or the like.

If the two data signals are adjacent image signals (e.g., image signals adjacent in time), there may be little difference in luminance, contrast, or the like, but parameters to be applied through image enhancement may change. Also, in a case of a low-resolution image of, e.g., about 64K, there may be a significant difference in one gradation.

Accordingly, as shown in FIGS. 1 to 4C, the output data calculated by using the N+1-th parameter and the output data calculated by using the N-th parameter are alternately output at least once (operation S506). Thus, outputting of an intermediate value smaller than a gradation value may be visually induced through the alternative outputting of the two pieces of output data.

After the above-described alternative outputting is finished, the output data calculated by using the N+1-th parameter is output (operation S507). Even though there may be a significant difference in a gradation value between the output data in which the N-th and N+1-th input data are image-enhanced (e.g., due to a low-resolution image), an effect of smoothly switching an image may be obtained through the above-described temporal property of vision. As shown in FIGS. 4B and 4C, two or more intermediate values may be between two gradations.

In the above-described embodiments, if the input data is a still image, variations in minute brightness of, e.g., ambient light may be sensed, and thus, when there is a need to change a gain corresponding to luminance during image enhancement, the gain may correspond to the above-described parameter.

Also, even when the input data is an image that slowly changes, that is, changes through a sliding operation, a relatively minute difference in luminance or contrast according to the change in the input data, and a specific gain for image enhancement may change. Here, application of the gain may correspond to the above-described parameter.

FIG. 5B illustrates a flowchart showing signal processing according to an embodiment.

Referring to FIG. 5B, N-th input data (for example, the current input data) is input to a signal processing apparatus (operation S511). Here, the N-th input data may have the same property as that of FIG. 5A. An N-th parameter is calculated by using the N-th input data (operation S512).

Here, the N-th parameter may be regarded as having materially the same definition as that of FIG. 5A.

Output data is calculated through a processing unit by using the N-th parameter and the input data, and a result of the calculation is output (operation S513), which may be regarded as the above-described image enhancement.

Next, N+1-th input data is input to the signal processing apparatus (operation S514). Then, an N+1-th parameter with respect to the N+1-th input data is calculated.

It may be determined whether to use a process of alternately outputting two pieces of output data (to which the N-th parameter and the N+1-th parameter are differently applied) at least once according to variations in the N-th parameter and the N+1-th parameter. In operation S515, the N-th parameter and the N+1-th parameter are compared with each other.

As a result of the comparison, if the N-th parameter and the N+1-th parameter are the same, the output data calculated through the processing unit by using the N+1-th parameter and the input data is output (operation S518).

Otherwise, if the N-th parameter and the N+1-th parameter are different from each other, two pieces of output data to which the N-th parameter and the N+1-th parameter are differently applied are alternately output at least once (operation S517).

In the above-described embodiments, the N+1-th parameter is calculated after inputting the N+1-th input data. However, as shown in FIG. 5B, an operation (operation S516) of calculating a parameter corresponding to the N+1-th input data may be performed between operations S515 and S517. Thus, a parameter with respect to the N+1-th input data may be calculated according to the result of the calculation that determines whether the parameter changes in operation S515 through the analysis result A0 provided by the analyzer 12 of FIG. 1 without first calculating the parameter with respect to the N+1-th input data in operation S514. The operation S515 may be performed by the controller 11, the analyzer 12, or the first and second parameter calculators 13 and 14 of FIG. 1.

Next, output data to which the second parameter with respect to the N+1-th input data is applied is output (operation S518).

Here, it is determined whether the parameter changes, and it is additionally determined based on a result of the determination whether two adjacent pieces of output data to which the different parameters are applied are alternately output for a predetermined period of time.

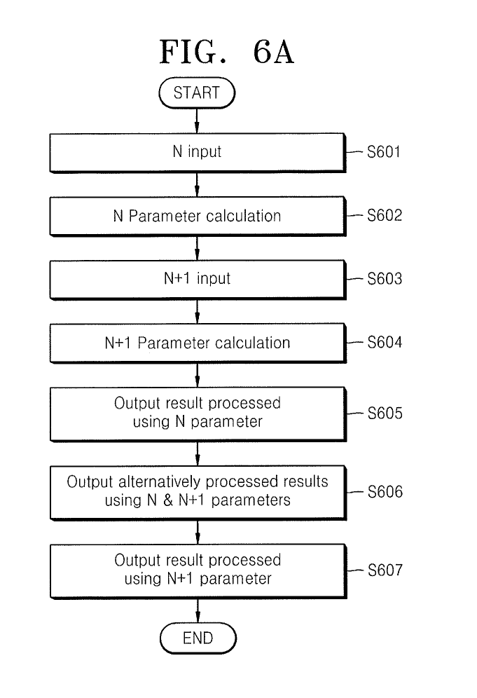

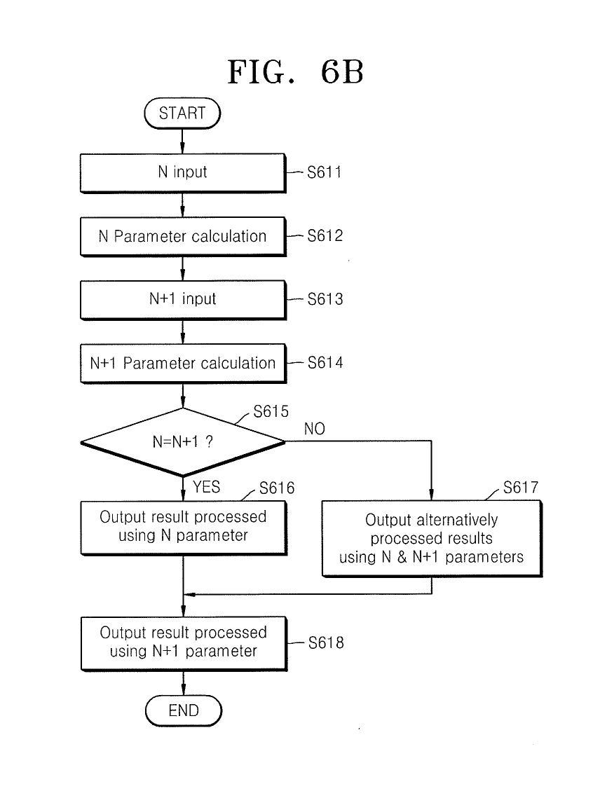

FIG. 6A illustrates a flowchart showing signal processing according to an embodiment.

Referring to FIG. 6A, N-th input data (for example, the current input data) is input to the signal processing apparatus (operation S601).

Here, the N-th input data may have the same property as those of FIGS. 5A and 5B. An N-th parameter is calculated by using the N-th input data (operation S602).

The N-th parameter may be regarded as having materially the same definition as those of FIGS. 5A and 5B.

Next, N+1-th input data is input to the signal processing apparatus (operation S603), and then an N+1-th parameter with respect to the N+1-th input data is calculated (operation S604).

Output data is calculated through a processing unit by using the N-th parameter and the input data, and a result of the calculation is output (operation S605). Here, the output data may be calculated by using the N+1-th input data and the N-th parameter.

Then, the output data calculated by using the N-th parameter and the output data calculated by using the N+1-th parameter are alternately output at least once (operation S606). Thus, outputting of a gradation that increases or decreases in a unit smaller than a reference unit may be visually induced through the alternative outputting of the two pieces of output data.

After the above-described repetitive output is finished, the output data calculated by using the N+1-th parameter is output (operation S607).

FIG. 6B illustrates a flowchart showing signal processing according to an embodiment.

Referring to FIG. 6B, N-th input data is input to a signal processing apparatus (operation S611). The N-th input data is the same as those of FIGS. 5A and 5B. An N-th parameter is calculated by using the N-th input data (operation S612). Here, the N-th parameter may be regarded as having materially the same meaning as those of FIGS. 5A and 5B.

A value of the N-th parameter is stored in the first parameter calculator 13 of FIG. 1 or a separate register.

Next, N+1-th input data is input to the signal processing apparatus (operation S613), and then an N+1-th parameter with respect to the N+1-th input data is calculated (operation S614).

It is determined whether to use a process of alternately outputting two pieces of output data (to which the N-th parameter and the N+1-th parameter are differently applied) at least once, according to variations in the N-th parameter and the N+1-th parameter. In operation S615, the N-th parameter and the N+1-th parameter are compared with each other.

As a result of the comparison, if the N-th parameter and the N+1-th parameter are the same, output data is calculated through a processing unit by using the N-th parameter and the input data, and a result of the calculation is output (operation S616). In operation S616, the N-th parameter and the N-th input data may be used in the calculation, which may be regarded as the above-described image enhancement.

Next, output data is calculated through the processing unit by using the N+1-th parameter and the input data, and a result of the calculation is output (operation S618). In operation S618, the N+1-th parameter and the N+1-th input data may be used in the calculation.

As a result of the comparison performed in operation S615, if the N-th parameter and the N+1-th parameter are different form each other, two pieces of output data (to which the N-th parameter and the N+1-th parameter are differently applied) are alternately output at least once (operation S617).

In the embodiments shown in FIGS. 6A and 6B, after the N-th parameter and the N+1-th parameter are calculated, the output data is calculated according to a result of the comparison between the N-th parameter and the N+1-th parameter. However, the processing unit may be separately disposed in each parameter, and the comparison between the N-th parameter and the N+1-th parameter may be performed after calculating the output data.

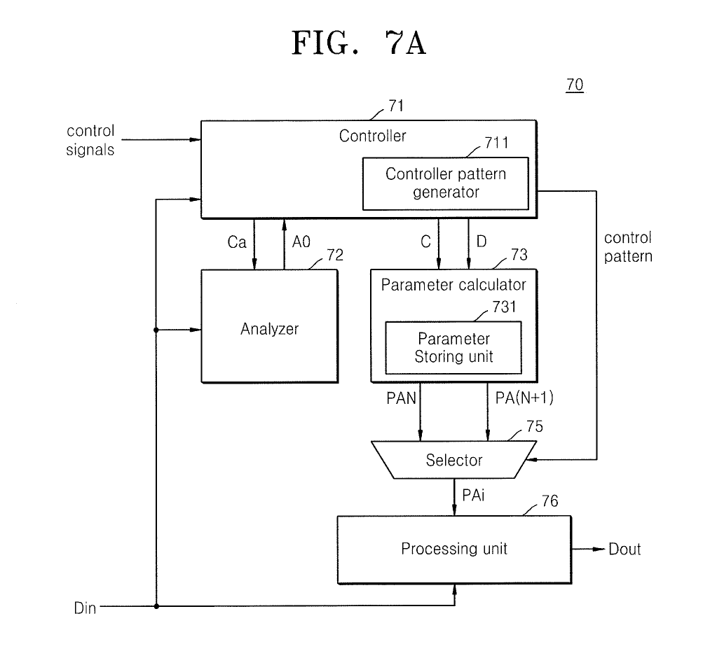

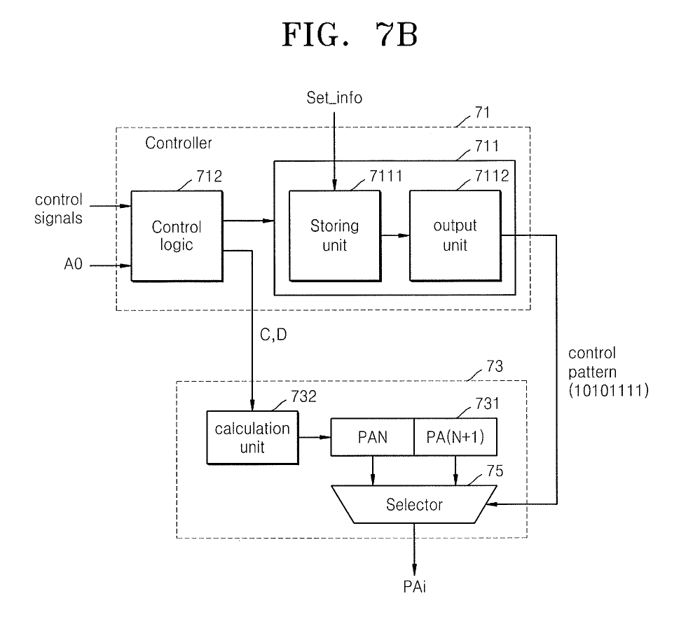

FIGS. 7A and 7B illustrate block diagrams of a signal processing apparatus according to an embodiment. In the above-described embodiments, the parameter calculators may be separately disposed, while in the current embodiment, a common parameter calculator may be used and generated parameters are stored in a storing unit such as a memory, a register, or the like.

Referring to FIG. 7A, a signal processing apparatus 70 may include an analyzer 72, a controller 71, a parameter calculator 73, a selector 75, and a processing unit 76.

The analyzer 72 may generate an analysis result A0 by analyzing input data Din and provides the generated analysis result A0 to the controller 71. The controller 71 may provide a control signal C and data D that are used to calculate a parameter in the parameter calculator 73. The parameter calculator 73 may generate at least one parameter and stores the generated parameter in a parameter storing unit 731. FIG. 7A shows an example where two parameters (PAN, PA(N+1)) are stored in the parameter storing unit 731, when pieces of output data calculated by using two parameters are alternately output. Alternatively, at least three parameters may be stored in the parameter storing unit 731 when pieces of output data calculated by using at least three parameters are alternately output.

The N-th parameter PAN is calculated from the input data Din of a predetermined frame (for example, an N-th frame), and output data Dout is generated based on the N-th parameter PAN and the input data Din. Then, as an image of the next frame (for example, an N+1-th frame) is changed, the N+1-th parameter PA(N+1) which may be different from the N-th parameter PAN is calculated.

Here, the output data Dout may be generated by using at least two parameters with respect to the input data Din of a predetermined number of frames including the N+1-th frame and subsequent frames so that an image may be smoothly switched by preventing a rapid change in a gradation. For example, when the above-described alternating outputting is applied to the input data Din of four frames, the output data Dout corresponding to the first frame may be generated by operating on the input data Din of the N+1-th frame and the N+1-th parameter PA(N+1), the output data Dout corresponding to the second frame may be generated by operating on the input data Din of an N+2 frame and the N-th parameter PAN, the output data Dout corresponding to the third frame may be generated by operating on the input data Din of an N+3 frame and the N+1-th parameter PA(N+1), and the output data Dout corresponding to the fourth frame may be generated by operating on the input data Din of an N+4 frame and the N-th parameter PAN. The selector 75 may selectively output the N-th parameter PAN and the N+1-th parameter PA(N+1) to the processing unit 76 according to a predetermined control pattern.

The controller 71 may include a control pattern generator 711 for generating the control pattern. The controller 71 may output the control pattern by using the input data Din, the analysis result A0 provided by the analyzer 72 and/or control signals applied from the outside. For example, the above-described output frequency control information may be previously set and stored as the control pattern in the control pattern generator 711, and the control pattern stored in the control pattern generator 711 in response to the analysis result A0, the control signals, or the like may be output to the selector 75.

According the an embodiment, a flicker (which may be generated because a gradation of the output data Dout is significantly changed) may be reduced. For example, when a gradation of output data is significantly changed from N-th to N+1, a variation width in the gradation may be visually recognized. However, according to the above-described embodiments, the gradation may be visually recognized as a unit smaller than a reference unit. According to the above-described embodiments, since the output data Dout having the gradation ‘N’ and the output data Dout having the gradation ‘N+1’ are alternately output with respect to a predetermined number of frames, the gradation may be changed to a unit smaller than a reference unit, e.g., N+½, N+⅓, etc.

FIG. 7B illustrates a block diagram showing an example of a detailed configuration of the signal processing apparatus 70 of FIG. 7A. The controller 71 may include a control logic 712 for performing the whole control operation (or a part of the control operation), and the control pattern generator 711 for storing and outputting a control pattern. The control logic 712 may control outputting of the control pattern in response to the analysis result A0 and/or the control signals applied from the outside.

The control pattern generator 711 may include a storing unit 7111 for storing the control pattern (e.g., based on Set_info) and an output unit 7112 for outputting the control pattern. The control pattern for controlling the selector 75 may be previously set and stored in the storing unit 7111. For example, as shown in FIGS. 4A to 4C, the control pattern may be stored in any of various forms. The control pattern generator 711 may uniformly output a signal (for example, “1”) having a predetermined value under the control of the control logic 712 or may output a control pattern having a predetermined pattern (for example, “10101111”).

In general, while frames having materially the same image are continuously input to the signal processing apparatus 70, a frame in which the image is changed may be input at a certain point in time, and then a frame having the same image may be continuously input. When the image is changed, a parameter value calculated based on the change in the image is also changed. After the point when the image is changed, output data generated by using the previous parameter and output data generated by using the current parameter are alternately output with respect to a predetermined number of frames, and the above-described selective outputting may be controlled by the control pattern stored in the storing unit 7111.

The parameter calculator 73 may include a calculation unit 732 for performing an operation and the parameter storing unit 731 for storing a generated parameter. Although the selector 75 is disposed outside the parameter calculator 73 in FIG. 7A, the selector 75 may be disposed inside the parameter calculator 73 as shown in FIG. 7B.

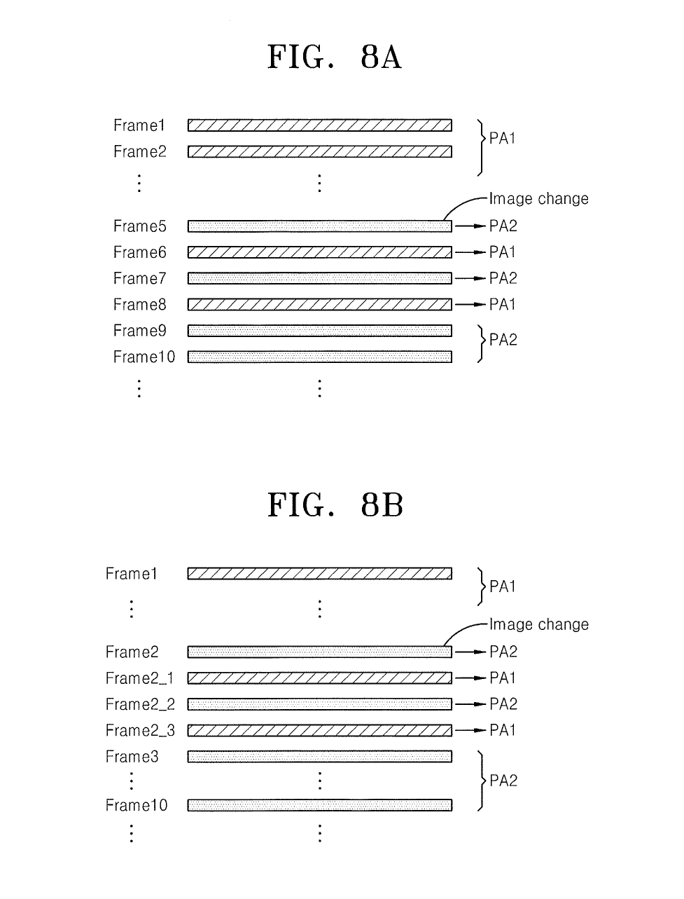

FIGS. 8A and 8B illustrate views showing an example of an optional output of a parameter according to an embodiment. FIG. 8A shows an example where a frequency of inputting a frame to a signal processing apparatus is the same as a frequency of outputting the frame from the signal processing apparatus. FIG. 8B shows an example where a frequency of inputting a frame to a signal processing apparatus is different from a frequency of outputting the frame from the signal processing apparatus. In FIG. 8B, the frequency of outputting the frame from the signal processing apparatus is four times the frequency of inputting the frame to the signal processing apparatus. For example, the frequency of inputting the frame to the signal processing apparatus is 30 Hz, and the frequency of outputting the frame from the signal processing apparatus is 120 Hz.

As shown in FIG. 8A, the frames having the same image are input in first to fourth frames Frame1 to Frame4, and the image may be changed in a fifth frame Frame5. Thus, parameters having materially the same value may be calculated in response to the first to fourth frames Frame1 to Frame4, which may be referred to as a first parameter PA1.

As the fifth frame Frame5 (in which the image is changed) is input, a second parameter PA2 having a value different from that of the first parameter PA1 may be calculated. Accordingly, output data may be generated by alternately selecting the first and second parameters PA1 and PA2 with respect to a predetermined number of frames after the fifth frame Frame5. When an operation of selecting the parameter is applied to the four frames, output data corresponding to input data of sixth and eighth frames Frame6 and Frame8 may be generated by performing an operation by using the first parameter PA1 and output data corresponding to input data of the fifth frame Frame5 and a seventh frame Frame7 may be generated by performing an operation by using the second parameter PA2. Then, a parameter may be calculated from input data of the corresponding frame after a ninth frame Frame9, and the parameter may be used to perform an operation. On the other hand, if an image of a frame is not changed, a parameter having a value that is the same as that of the second parameter PA2 is applied to an operation.

FIG. 8B shows an example where an image is changed in the second frame Frame2. The first parameter PA1 corresponding to the first frame Frame1 may be calculated, and pieces of output data corresponding to four frames may be generated by using the first parameter PA1. Then, as the second frame Frame2 in which the image is changed is input, the second parameter PA2 having a value different from that of the first parameter PA1 may be calculated.

Pieces of output data corresponding to four frames Frame2, Frame2_1, Frame2_2, and Frame2_3 are generated by using the input data of the second frame Frame2 and at least two parameters. For example, the pieces of output data corresponding to the two frames Frame2 and Frame2_2 may be generated by using the second parameter PA2, and the pieces of output data corresponding to the two frames Frame2_1 and Frame2_3 may be generated by using the first parameter PA1. Regarding a subsequent frame to be input, a parameter is calculated by using input data of the corresponding frame. If pieces of input data of third and fourth frames Frame3 and Frame4 are the same as the input data of the second frame Frame2, output data is generated based on a parameter having a value that is materially the same as that of the second parameter PA2.

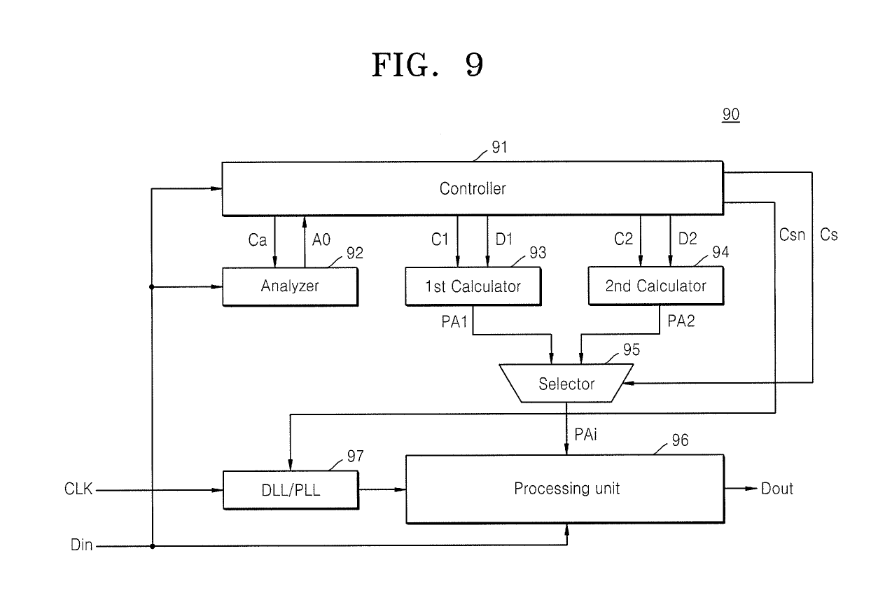

FIG. 9 illustrates a block diagram of a signal processing apparatus 90 according to another embodiment of the inventive concept.

Referring to FIG. 9, the elements of the signal processing apparatus 90 may be materially the same as those of the signal processing apparatus 10 of FIG. 1, and thus, a detailed description thereof will not be repeated.

A DLL/PLL 97 may receive a clock signal CLK and may control a data output timing of output data Dout of a processing unit 96 according to a control signal Csn provided by a controller 91. If the data output timing of the output data Dout is controlled, an output timing of, for example, a display apparatus receiving the control signal Csn may be controlled.

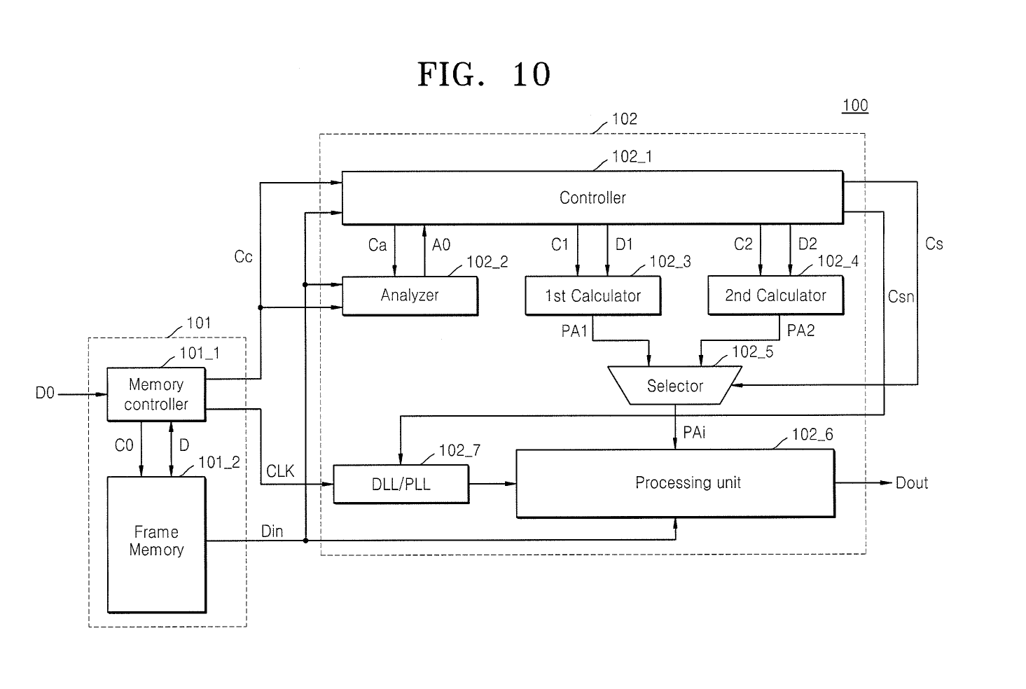

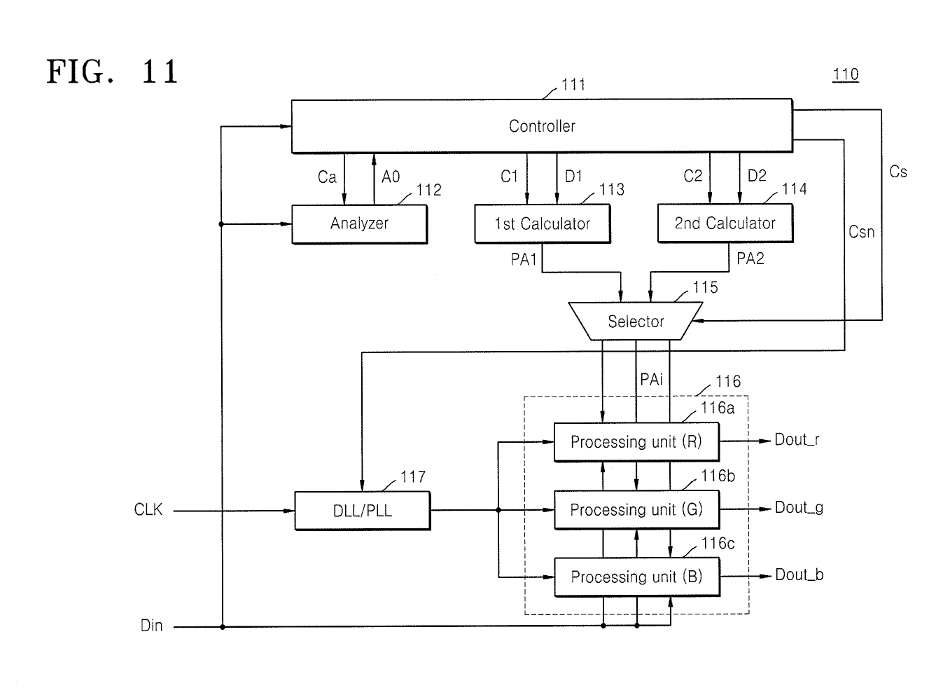

FIG. 10 illustrates a block diagram of an image signal processing apparatus 100 including the signal processing apparatus 90 of FIG. 9.

Referring to FIG. 10, the image signal processing apparatus 100 may include a signal processing apparatus 102 as the signal processing apparatus 90 of FIG. 9 and a graphic memory 101. The graphic memory 101 may be materially the same as the graphic memory 21 of FIG. 2, and thus, a detailed description thereof will not be repeated. In addition, the signal processing apparatus 102 may be materially the same as the signal processing apparatus 90 of FIG. 9, and thus, a detailed description thereof will not be repeated.

A memory controller 101_1 may provide a clock signal CLK to a DLL/PLL 102_7 of the signal processing apparatus 102. Also, the memory controller 101_1 may further include a clock generator as well as the DLL/PLL (not shown).

FIG. 11 illustrates a block diagram of a signal processing apparatus 110 according to an embodiment.

Referring to FIG. 11, the signal processing apparatus 110 has a structure in which the DLL/PLL 97 is connected to the signal processing apparatus 30 of FIG. 3. Thus, the signal processing apparatus 110 of FIG. 11 may be different from the signal processing apparatus 90 of FIG. 9 in that output data (image signal) of each RGB color is output by the signal processing apparatus 110 of FIG. 11, and the signal processing apparatus 110 of FIG. 11 may performs materially the same operation as the signal processing apparatus 30 of FIG. 3, and thus, a detailed description thereof will not be repeated.

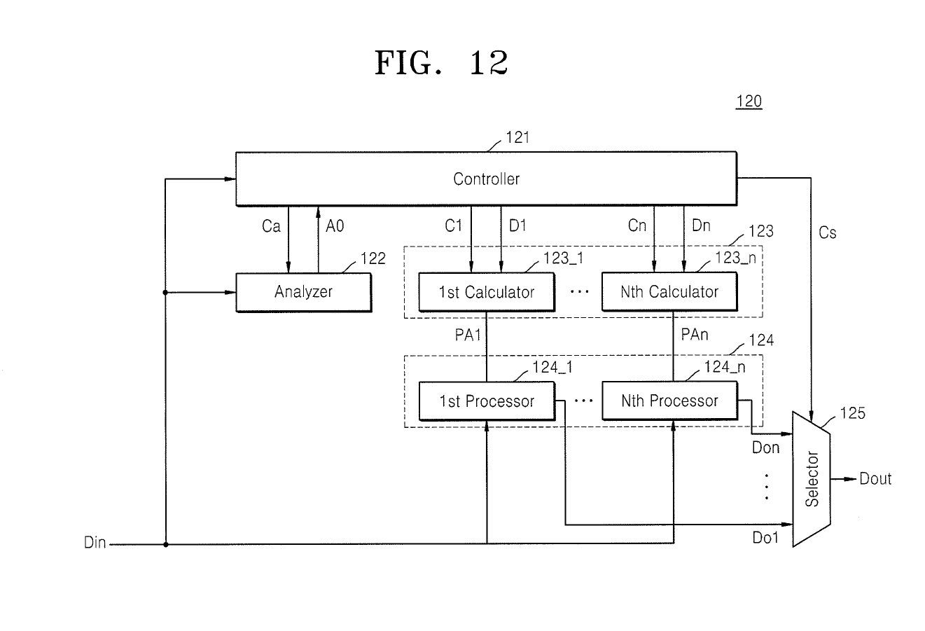

FIG. 12 illustrates a block diagram of a signal processing apparatus 120 according to an embodiment.

Referring to FIG. 12, the signal processing apparatus 120 may include an analyzer 122, a controller 121, a parameter calculator 123, a processor 124, and a selector 125.

The parameter calculator 123 includes n-unit parameter calculators 123_1 to 123_{—}n, wherein n is a natural number. The processor 124 may include n-unit processors 124_1 to 124_{—}n, wherein n may vary according to the number of values of a signal that are smaller than a minimum gradation unit and exist between two image signals adjacent to each other in terms of time according to a variation in a parameter. For example, if the signal has one intermediate value, the parameter calculator 123 may include two unit parameter calculators 123_1 to 123_{—}n and two unit processors 124_1 to 124_{—}n, and if the signal has two intermediate values, the parameter calculator 123 may include three unit parameter calculators 123_1 to 123_{—}n and three unit processors 124_1 to 124_{—}n.

In addition, here, the processor 124 may include a plurality of the unit processors 124_1 to 124_{—}n that calculate a plurality of pieces of output data D01 to D0n according to a plurality of parameters PA1 to PAn and input data Din, respectively. The calculated output data D01 to D0n may be selectively output by the selector 125.

The selector 125 may selectively output the pieces of output data D01 to D0n in response to a control signal Cs provided by the controller 121. The control signal Cs may select one of the pieces of output data D01 to D0n based on an analysis result A0 and output frequency control information. The selected signal may be output as a final output data Dout.

The output frequency control information refers to information for controlling the number of pieces of data adjacent to each other in terms of time, e.g., two pieces of data, that are alternately and repeatedly output. The analyzer 122 may be periodically operated. For example, the period may be one frame when the input data Din is a video signal. In addition to the periodic operation, the analyzer 122 may perform an analysis operation through control from the outside only when the input data Din changes, and may not perform the analysis operation if the input data Din does not change. For example, if the video signal is a still image signal, it may be highly unlikely that the input data Din changes, and thus the analyzer 122 may skip the analysis operation.

The controller 121 may perform a control operation on itself, or may be controlled according to control signals (not shown) provided from the outside. Although the controller 121 is shown as an individual element in FIG. 12, the controller 121 may include the analyzer 12, the parameter calculator 123, and/or the selector 125.

The parameter calculator 123 may calculate a parameter with respect to the corresponding data by using the analysis result A0 of the analyzer 122. If there are three pieces of data that are alternately output, three parameter calculators may be used to correspond to the three pieces of data.

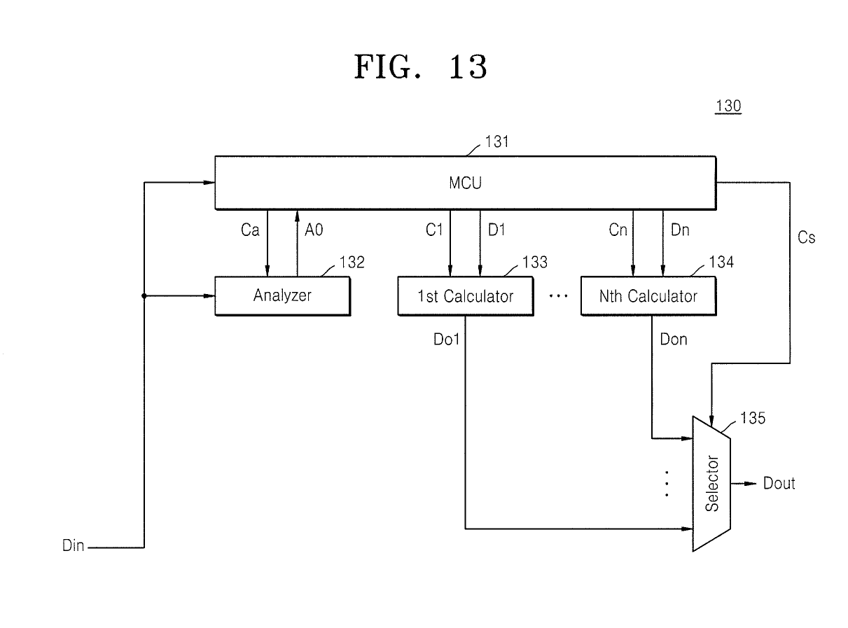

FIG. 13 illustrates a block diagram of a signal processing apparatus 130 according to an embodiment.

Referring to FIG. 13, the signal processing apparatus 130 may include an analyzer 132, a micro-control unit 131, a plurality of parameter calculators 133 and 134, and a selector 135.

In FIG. 13, the parameter calculator 123 and the processor 124 of FIG. 12 are combined with each other. Thus, calculating and processing of a parameter may be performed by one unit (e.g., the parameter calculators 133 and 134). Other elements and operations of the signal processing apparatus 130 may be materially the same as those of the above-described embodiments, and thus, a detailed description thereof will not be repeated.

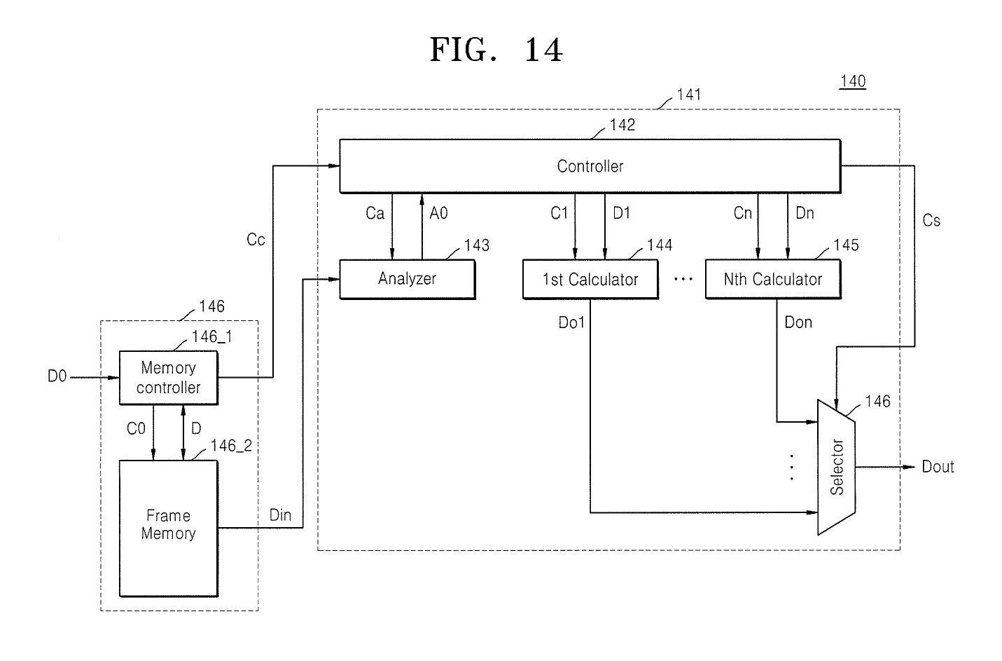

FIG. 14 illustrates a block diagram of an image signal processing apparatus 140 including the signal processing apparatus 130 of FIG. 13.

Referring to FIG. 14, the image signal processing apparatus 140 may include a signal processing apparatus 141 and a graphic memory 146. The graphic memory 146 may be materially the same as the graphic memory 21 of FIG. 2 and the graphic memory 101 of FIG. 101, and thus, a detailed description thereof will not be repeated. In addition, the signal processing apparatus 141 may be materially the same as the signal processing apparatus 130 of FIG. 13, and thus, a detailed description thereof will not be repeated.

In the embodiments of FIGS. 9 to 14, calculators for calculating parameters are separated from each other, but the embodiments are not limited thereto. For example, the DLL/PLL of FIG. 9, 10, or 11 may be combined with the signal processing apparatus 70 of FIGS. 7A and 7B, or alternatively, a plurality of the unit processors of FIG. 12, 13, or 14 may be combined with the signal processing apparatus 70 of FIGS. 7A and 7B.

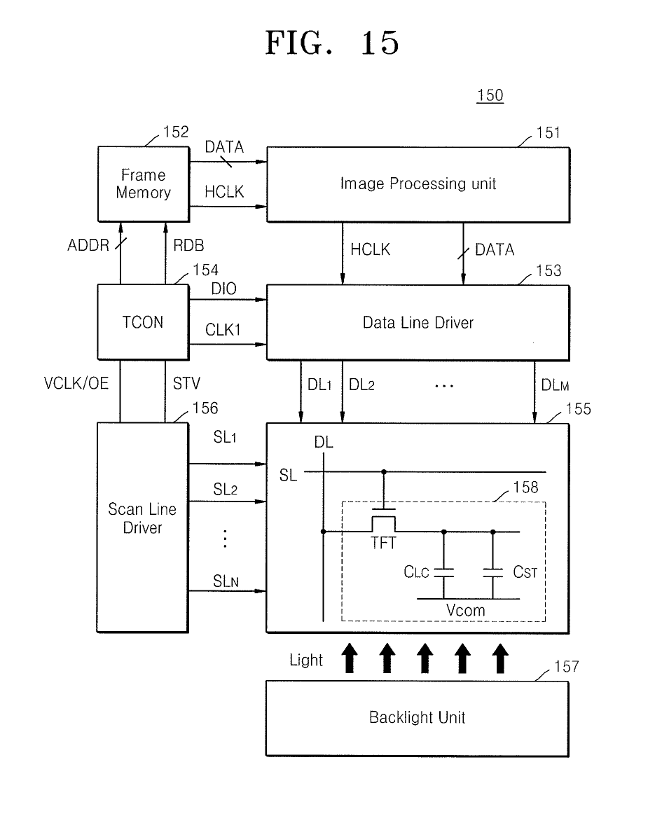

FIG. 15 illustrates a block diagram of a display apparatus 150 according to an embodiment.

Referring to FIG. 15, the display apparatus 150 may include a liquid crystal panel 155, a data line driver 153, a scan line driver 156, a timing controller 154, a backlight unit 157, a frame memory 152, and an image processing unit 151.

The frame memory 152 and the image processing unit 151 may include the embodiments of the signal processing apparatus described with reference to FIGS. 1 to 3 and 9 to 14. In other words, during switching of an image, data of the current frame and data of the subsequent frame may be repeatedly output in a plurality of steps so that the smooth switching of the image may be improved through a temporal visual effect (such that the gradation appears to be smaller than a minimum gradation unit).

The timing controller 154 may receive data input from an external graphic controller (not shown), i.e. image data, a control signal, for example, vertical and horizontal synchronization signals, a main clock, a data enable signal, etc. The timing controller 154 may process the image data in accordance with the operation condition of the liquid crystal panel 155, may generate a control signal for the scan line driver 156 and a control signal for the data line driver 153, and/or may transmit the control signal for the scan line driver 156 and the control signal for the data line driver 153 to the scan line driver 156 and the data line driver 153, respectively. In this regard, the control signal for the scan line driver 156 may include a vertical start signal STV instructing to start outputting a gate voltage and an output enable signal OE controlling an activation section of the gate voltage. The control signal for the data line driver 153 may include a horizontal start signal DIO instructing to start transmitting the image data DATA and an output control signal CLK1 applying an analog gradation signal to a corresponding data line DL.

The frame memory 152 may receive a data read command RDB and an address ADDR from the timing controller 154. The frame memory 152 may receive a horizontal synchronization signal HCLK and the image dada DATA from the external graphic controller (not shown), and may provide the image processing unit 151 with the horizontal synchronization signal HCLK and the image dada DATA.

The image processing unit 151 may have materially the same construction as the signal processing apparatuses described with reference to FIGS. 1 to 3 and 9 to 14.

The data line driver 153 may include a plurality of data driver ICs (not shown). The scan line driver 156 may include a plurality of scan driver ICs (not shown). The display apparatus 150 may not emit light itself but may adjust transmittance of light and displays an image, and thus may need a separate light source. The display apparatus 150 may include the backlight unit 157 as a light source. Thus, the display apparatus 150 may display the image by allowing light of the backlight unit 157, such as a light emitting diode (LED), that may be disposed on the rear side of the liquid crystal panel 155 to be incident to the liquid crystal panel 155, and, the liquid crystal panel 155 may adjust an amount of transmitted light according to an arrangement of liquid crystals.

The backlight unit 157 may be environmentally friendly and may be capable of a high speed response at, e.g., several nano-seconds and impulse driving.

The liquid crystal panel 155 may include a plurality of scan lines SL₁ through SL_{N} extending in one direction, a plurality of data lines DL₁ through DL_{N} extending in a direction orthogonal to the direction in which the scan lines SL₁ through SL_{N} extend, and a pixel region 158 disposed near a region in which the scan lines SL₁ through SL_{N} and the data lines DL₁ through DL_{N} cross each other. The pixel region 158 may include a unit pixel including a thin film transistor TFT, a liquid crystal capacitor C_{LC}, and a storage capacitor Cst. Accordingly, the thin film transistor TFT may be turned on and off according to a driving signal applied to the scan lines SL₁ through SL_{N}, may supply an analog gradation signal supplied through the data lines DL₁ through DL_{N} to a pixel electrode, and may change electric fields between both terminals of the liquid crystal capacitor C_{LC}. Thus, transmittance of the light supplied from the LED backlight unit 157 may be adjusted by changing the arrangement of liquid crystals (not shown).

A driving voltage generating unit (not shown) may generate various driving voltages used for driving the liquid crystal panel 155 by using an external power source of an external power source apparatus. The driving voltage generating unit may receive a first power source from the outside, and may generate a second power source to be provided to the data line driver 153, a gate turn-on voltage and a gate turn-off voltage provided to the scan line driver 156, and a common voltage Vcom provided to the liquid crystal panel 155.

The scan line driver 156 may apply gate on/off voltages of the driving voltage generating unit (not shown) to the scan lines SL₁ through SL_{N} in response to the vertical start signal STV, a vertical synchronization signal VCLK, and the output enable signal OE provided from the timing controller 154. Accordingly, the thin film transistor TFT may be turned on in such a way that the analog gradation voltage output from the data line driver 153 is applied to a corresponding pixel.

The data line driver 153 may generate an analog gradation signal corresponding to digital image data in response to the control signal for the data line driver 153 from the timing controller 154, and may apply the analog gradation signal to the data lines DL₁ through DL_{N} of the liquid crystal panel 155.

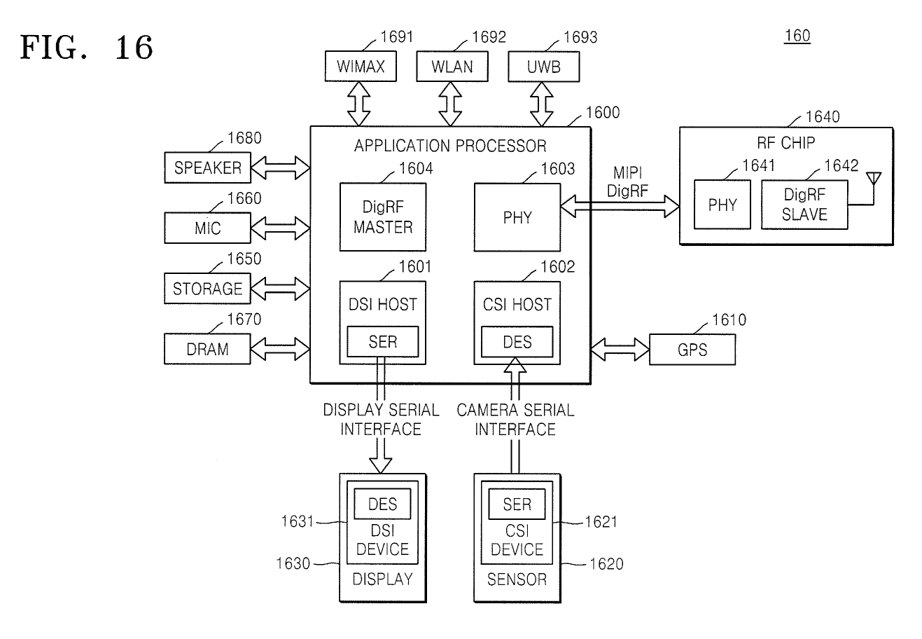

FIG. 16 illustrates a block diagram of an example of an interface used in a computing system 160 according to an embodiment.

Referring to FIG. 16, the computing system 160 may be implemented as a data processing apparatus capable of using or assisting a mobile industry processor interface (MIPI), and may include an application processor (AP) 1600, an image sensor 1620, and a display 1630. A camera serial interface (CSI) host 1602 of the AP 1600 may perform serial communication with a CSI device 1621 of the image sensor 1620 through a CSI. The CSI host 1602 may include a deserializer (DES), and the CSI device 1621 may include a serializer (SER). The display 1630 may include the construction described with reference to FIG. 15.

A display serial interface (DSI) host 1601 of the AP 1600 may perform serial communication with a DSI device 1631 of the display 1630 through a DSI. The DSI host 1601 may include a SER, and the DSI device 1631 may include a DES. The computing system 160 may further include a radio frequency (RF) chip 1640 that communicates with the AP 1600. A PHY 1603 of the AP 1600 and a PHY 1641 of the RF chip 1640 may transmit and receive data to and from each other according to the MIPI DigRF interface. The AP 1600 may further include a DigRF master 1604 that controls transmission and reception of data according to MIPI DigRF.

The computing system 160 may include a global positioning system (GPS) 1610, a storage 1650, a microphone 1660, a DRAM 1670, a speaker 1680. The computing system 160 may also perform communication using an ultra wideband (UWB) 1693, a wireless local area network (WLAN) 1692, and a worldwide interoperability for microwave access (WiMAX) 1691. However, the structure and interface of the computing system 160 are merely exemplary, and the embodiments are not limited thereto.

By way of summary and review, embodiments relate to an apparatus and method for processing a signal by which an image may be smoothly switched by using a virtual resolution during a process of switching an image signal without visually recognizing a minimum expression range that may occur due to a variation in a parameter between frames. In the embodiments, the image may be recognized as a unit smaller than a minimum expression range during a process of switching an image signal. For example, when a gradation of output data is significantly changed from N to N+1, a variation width in the gradation may be visually recognized (e.g., as a flicker). However, according to the embodiments (in which the ‘N’ and ‘N+1’ output data are alternately output) the gradation may be visually recognized as a unit smaller than the variation width, e.g., N+½, N+⅓, etc. Accordingly, the image signal may be visually recognized as a unit smaller than a minimum expression range of the image signal and thus smooth switching, and picture quality of an image signal, may be improved.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method of processing a signal, the method comprising:
receiving first data;
extracting a first parameter from the first data;
calculating and outputting first output data with respect to the first data based on the first parameter;
receiving second data;
extracting a second parameter from the second data;
calculating second output data with respect to the second data based on the second parameter; and
alternately outputting the first and second output data at least once.

2. The method as claimed in claim 1, further comprising outputting the second output data after alternately outputting the first and second output data.

3. The method as claimed in claim 1, wherein the first parameter and the second parameter have different values.

4. The method as claimed in claim 1, wherein the first and second output data are output in units of frames.

5. The method as claimed in claim 1, wherein:
the first and second output data respectively have first and second gradations from among K-gradations, wherein K is a positive integer, and
alternately outputting the first and second output data visually appears as third output data having at least one gradation between the first gradation and the second gradation.

6. The method as claimed in claim 5, wherein the K-gradations have gradation values that increase or decrease according to a reference unit, and the third output data appears to have a gradation value that increases or decreases according to a unit smaller than the reference unit.

7. The method as claimed in claim 5, wherein the third output data comprises a plurality of frames.

8. A method of processing a signal, the method comprising:
receiving first data;
extracting a first parameter from the first data;
receiving second data;
extracting a second parameter from the second data;
comparing the first parameter and the second parameter; and
as a result of the comparison, if the first and second parameters are different from each other, at least once alternately outputting first output data generated based on the first parameter and second output data generated based on the second parameter.

9. The method as claimed in claim 8, wherein, as a result of the comparison, if the first parameter is the same as the second parameter, the second output data generated based on the second parameter is output.

10. The method as claimed in claim 8, further comprising outputting the second output data after alternately outputting the first and second output data.

11. The method as claimed in claim 8, wherein:
the first and second output data respectively have first and second gradations from among K-gradations, wherein K is a positive integer, and
alternately outputting the first and second output data visually appears as third output data having at least one gradation between the first gradation and the second gradation.

12. A signal processing apparatus, comprising:
a parameter calculator for calculating a first parameter for first data and a second parameter for second data;
a processing unit for generating first output data based on the first parameter and second output data based on the second parameter; and
a controller for controlling the first and second output data to be alternately output at least once if the first and second parameters are different from each other.

13. The signal processing apparatus as claimed in claim 12, further comprising an analyzer for analyzing the first and second data to output a result of the analysis to the controller.

14. The signal processing apparatus as claimed in claim 13, wherein the controller compares the first and second parameters.

15. The signal processing apparatus as claimed in claim 12, further comprising a selector for receiving the first and second parameters and selectively outputting the first and second parameters to the processing unit under the control of the controller.

16. The signal processing apparatus as claimed in claim 12, wherein the controller controls the second output data to be output if the first parameter is the same as the second parameter.

17. The signal processing apparatus as claimed in claim 12, wherein the controller controls the second output data to be output after the first and second output data are alternately output, if the first and second parameters are different from each other.

18. The signal processing apparatus as claimed in claim 12, wherein the controller comprises a control pattern generator for generating a control pattern that controls the first and second output data to be alternately output at least once.

19. The signal processing apparatus as claimed in claim 12, wherein the processing unit generates the first and second output data by operating on some data selected from the second data to n-th data with the first parameter and operating on other data selected from the second data to the n-th data with the second parameter, wherein n is an integer equal to or greater than 3.

20. The signal processing apparatus as claimed in claim 12, wherein the processing unit generates the first output data by enhancing a first image signal based on the first processing parameter to produce a first enhanced image signal, and generates the second output data by enhancing a second image signal based on the second processing parameter to produce a second enhanced image signal.
